(19) United States
(12) Patent Application Publication
(10) Pub. No.: US 2009/0259012 A1
(43) Pub. Date: Oct. 15, 2009

(54) UREA-TERMINATED ETHER POLYURETHANES AND AQUEOUS DISPERSIONS THEREOF

(76) Inventor: C. CHAD ROBERTS, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/327,194

(22) Filed: Dec. 3, 2008

Related U.S. Application Data
(60) Provisional application No. 61/005,963, filed on Dec. 10, 2007.

(51) Int. Cl. C08L 75/04

(52) U.S. Cl. 528/66

(57) ABSTRACT

The present invention relates to water-dispersible urea terminated ether type polyurethanes based on polyether diols, aqueous dispersions of such polyurethanes, and their manufacture. The urea termination can have nonionic hydrophilic substituents.

### CROSS-REFERENCE TO RELATED APPLICATION

This application claims priority under 35 U.S.C. §119 from U.S. Provisional Application Ser. No. 61/005,963 (filed Dec. 10, 2007), the disclosure of which is incorporated by reference herein for all purposes as if fully set forth.

### FIELD OF THE INVENTION

The present invention relates to water-dispersible urea-terminated polyurethanes based on certain polyether diols, aqueous dispersions of such polyurethanes, ink jet inks of such aqueous dispersions and their manufacture.

### BACKGROUND OF THE INVENTION

Polyurethanes are materials with a substantial range of physical and chemical properties, and are widely used in a variety of applications such as coatings, adhesives, fibers, foams and elastomers. For many of these applications the polyurethanes are used as organic solvent-based solutions. However, recently environmental concerns have caused solvent-based polyurethanes to be replaced by aqueous dispersions in many applications.

Polyurethane polymers, for the purposes of the present disclosure, are polymers wherein the polymer backbone contains urethane linkage derived from the reaction of an isocyanate group (from, e.g., a di- or higher-functional monomeric, oligomeric and/or polymeric polyisocyanate) with a hydroxyl group (from, e.g., a di- or higher-functional monomeric, oligomeric and/or polymeric polyol). Such polymers may, in addition to the urethane linkage, also contain other isocyanate-derived linkages such as urea, as well as other types of linkages present in the starting polyisocyanate components and/or polyol components (such as, for example, ester type and ether type linkage).

Polyurethane polymers can be manufactured by a variety of well-known methods, but are often prepared by first making an isocyanate-terminated “prepolymer” from polyols, polyisocyanates and other optional compounds, then chain-extending and/or chain-terminating this prepolymer to obtain a polymer possessing an appropriate molecular weight and other properties for a desired end use. Tri- and higher-functional starting components can be utilized to impart some level of branching and/or crosslinking to the polymer structure (as opposed to simple chain extension).

Polyurethanes have been prepared from diols as disclosed in Statutory Invention Registration US H2113 but with the limitation that the polyurethane has a hydroxyl number greater than 10 and thus the polyurethanes described are not urea terminated. Polyurethane have been prepared from polyether diols as disclosed in EP1167466, US2004/0092622 and US2003/0184629 but these polyurethanes are chain extended with di or triamines, which will result in a polyurethane which has been bridged by the di or triamine chain extension. US2004/0229976, in particular, describes the use of water-dispersible polyurethane resins in pigment-dispersed aqueous recording liquid which have at most 2.0 wt % of polyurethane urea in the polyurethane resin.

Polyurethanes have also been prepared using polytrimethylene ether glycol (“PO3G”) PO3G based homo and copolymers, as disclosed in U.S. Pat. No. 6,852,823, U.S. Pat. No. 6,946,539, US2005/0176921A1, co-owned and co-pending U.S. patent application Ser. No. 11/294,850 (filed Dec. 6, 2005), and Conjeevaram et al. (J Polym Sci, 23, 429, (1985)) (the disclosures of which are incorporated by reference herein for all purposes as if fully set forth). The most common source of PO3G and its precursors are from biosynthetic pathways that are described in the aforementioned patents and applications. Polyurethanes derived at least in part from biosynthetic pathways are important nowadays, as they reduce our reliance on the petrochemical industry.

As noted above, for environmental reasons, aqueous dispersions of polyurethanes have also been proposed. Aqueous dispersions of polyurethanes have found application in numerous end uses, including but not limited to pigmented and colorless coatings, textile treatments, paints, printing inks, adhesives and surface finishes. In general these polyurethane dispersions are added to the formulations as a freely added material and as such behave as non-interacting resin in the formulation. While the previously described polyurethane resins can be formulated into aqueous dispersions and used as additives for various formulations, especially for pigments and pigmented inks for inkjet inks and the formulations are commonly improved in some performance parameters, there is often, however, a degradation in other formulation properties. For example, polyurethane resin additives to aqueous ink jet inks can improve the smear and water resistance of the printed image, but these inks are inferior relative to thermal stability and often cannot be used in thermal ink jet devices. Thus, there is still a need for polyurethane resins and dispersions thereof which provide improved performance in most if not all of the properties of the formulations.

None of the above publications disclose water dispersible urea-terminated ether type polyurethanes based on certain polyols which have at least at least 2 diols in the polyether and at least 3 but less than 12 (substituted) methylene groups between the hydroxyl groups of the diol. This novel class of polyurethanes discovered herein, which can also be derived in part from biosynthetic pathways, possess a unique balance of properties and do not elevate one property at the expense of some others.

### SUMMARY OF THE INVENTION

The use of polyurethanes as additives for paints, ink jet inks etc. or as dispersants for pigments and other particles are well established as a means to make paints and inks with improved properties. During diligent searching for new, improved urea terminated polyurethanes, a new class of polyurethanes has been found that are based on urea terminated polyurethanes, where the predominant isocyanate reactive group is a hydroxyl which is at least part derived from certain polyether diols. The ionic content in these dispersants can come from isocyanate or isocyanate-reactive components that have ionic substitution.

In one aspect, the present invention relates to an aqueous dispersion of a polyurethane composition comprising a urea-terminated polyurethane where the urea-terminated polyurethane dispersant comprises at least one compound of the general structure (I):

### (I):

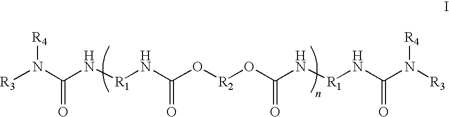 [0013] R₁=alkyl, substituted alkyl, substituted alkyl/aryl from a diisocyanate,
R₂=alkyl, substituted/branched alkyl from a diol,
R₃=alkyl, a non-isocyanate reactive substituted/branched alkyl from an amine terminating group,
R₄=hydrogen, alkyl, a non-isocyanate reactive substituted/branched alkyl from the amine terminating group;
n=2 to 30;
and where R₂=Z₁ or Z₂ and at least one Z₁ and at least one Z₂ must be present in the polyurethane composition;

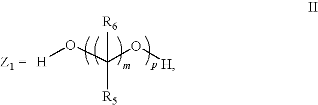

m greater than or equal to 3 to about 12,
p greater than or equal to 2,
R₅, R₆=hydrogen, alkyl, substituted alkyl, aryl; where the R₅ is the same or different with each —CR₅R₆; where R₅ and R₅ or R₆ can be joined to form a cyclic structure;
Z₂ is a diol substituted with an ionic group;

wherein the urea content of the urea-terminated polyurethane of general structure (I) is at least 2 wt % of the polyurethane and at most about 14 wt % of the polyurethane.

Structure I denotes the urea terminating component and Structure II denotes the polyether diol that is a building block for Structure I.

The present invention also relates to aqueous dispersions comprising a continuous phase comprising water, and a dispersed phase comprising the water-dispersible urea terminated polyurethane. The present invention further relates to an aqueous polyurethane composition comprising a urea-terminated polyurethane is as generally set forth above, wherein it contains a sufficient amount of ionic functionality in order to render the polyurethane dispersible in the continuous phase of the dispersion. Preferably, the polyurethane is an ionically-stabilized polyurethane polymer.

The continuous phase of the aqueous dispersion, in addition to water, may further comprise water-miscible organic solvent. A preferred level of organic solvent is from about 0 wt % to about 30 wt %, based on the weight of the continuous phase.

The dispersed phase of the aqueous dispersion is preferably from about 10 wt % to about 55 wt % of the total weight of the dispersion.

The invention also relates to a method of preparing an aqueous dispersion of an aqueous polyurethane composition comprising a urea terminated polyurethane comprising the steps:

(a) providing reactants comprising (i) a polyether diol {Structure II} component comprising a diol, (ii) a polyisocyanate component comprising a diisocyanate, and (iii) a hydrophilic reactant comprising a compound selected from the group consisting of (1) mono or diisocyanate containing an ionic group, and (2) an isocyanate reactive ingredient containing an ionic group;

(b) contacting (i), (ii) and (iii) in the presence of a water-miscible organic solvent to form an isocyanate-functional polyurethane prepolymer;

(c) adding water to form an aqueous dispersion; and

(d) prior to, concurrently with or subsequent to step (c), chain-terminating the isocyanate-functional prepolymer with a primary or secondary amine.

The chain terminating amine is typically added prior to addition of water in an amount to react with substantially any remaining isocyanate functionality. The chain terminating amine is preferably a nonionic secondary amine.

If the hydrophilic reactant contains ionizable groups then, at the time of addition of water (step (c)), the ionizable groups must be ionized by adding acid or base (depending on the type of ionizable group) in an amount such that the polyurethane can be stably dispersed.

Preferably, at some point during the reaction (generally after addition of water and after chain extension), the organic solvent is substantially removed under vacuum to produce an essentially solvent-free dispersion.

Aqueous dispersions of urea terminated polyurethanes based on polyether diols shown in Structure II above potentially offer a novel and unique balance of dispersibility, hydrophilicity, flexibility, toughness, and processability. The use of these polyether diols provides improved water resistance and lower melting point compared to polyethylene glycol (PEG). These urea terminated polyurethane compositions are more flexible, more dispersible and have improved interactions with pigments and other components than polyurethanes derived from polyethyene glycol (PEG) or poly(1,2-propylene glycol) (PPG). For the polyurethane aqueous dispersions (PUD), the use of the urea-terminated polyurethane with polyether diols (Structure II) also offers new balance of properties whereas previous PUD developments were limited to PPG, PEG, and PO4G and were terminated with isocyanate reactive groups, typically alcohols, thus leading to a urethane/alcohol terminated polyurethane.

In general, these polyurethane dispersions are added to the formulations as a freely added material and as such behave as non-interacting resin in the formulation. Alternatively, these polyurethanes can be used as dispersants for pigments, pharmaceuticals and other small particles.

### DETAILED DESCRIPTION OF THE PREFERRED EMBODIMENTS

All publications, patent applications, patents and other references mentioned herein, if not otherwise indicated, are incorporated by reference herein for all purposes as if fully set forth.

Unless otherwise defined, all technical and scientific terms used herein have the same meaning as commonly understood by one of ordinary skill in the art to which this invention belongs. In case of conflict, the present specification, including definitions, will control.

Except where expressly noted, trademarks are shown in upper case.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Use of “a” or “an” are employed to describe elements and components of the invention. This is done merely for convenience and to give a general sense of the invention. This description should be read to include one or at least one and the singular also includes the plural unless it is obvious that it is meant otherwise.

The materials, methods, and examples herein are illustrative only and, except as specifically stated, are not intended to be limiting. Although methods and materials similar or equivalent to those described herein can be used in the practice or testing of the present invention, suitable methods and materials are described herein.

### Water-Dispersible Urea-terminated Polyether Polyurethanes

The polyurethane is a urea terminated polyurethane of the Structure I).

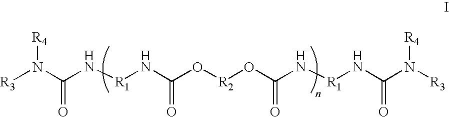

R₁=alkyl, substituted alkyl, substituted alkyl/aryl from a diisocyanate,
R₂=alkyl, substituted/branched alkyl from a diol,
R₃=alkyl, a non-isocyanate reactive substituted/branched alkyl from an amine terminating group,
R₄=hydrogen, alkyl, a non-isocyanate reactive substituted/branched alkyl from the amine terminating group;
n=2 to 30;
and where R₂=Z₁ or Z₂ and at least one Z₁ and at least one Z₂ must be present in the polyurethane composition;

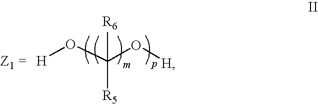

m greater than or equal to 3 to about 12,
p greater than or equal to 2,
R₅, R₆=hydrogen, alkyl, substituted alkyl, aryl; where the R₅ is the same or different with each —CR₅R₆; where R₅ and R₅ or R₆ can be joined to form a cyclic structure;
Z₂ is a diol substituted with an ionic group;
   wherein the urea content of the urea-terminated polyurethane of general structure I is at least 2 wt % and at most about 14 wt % of the polyurethane.

Structure I denotes the urea terminated polyurethane and Structure II denotes the polyether diol that is a building block for Structure I.

The polyurethane is prepared from ingredients comprising

(a) a polyether diol component comprising the polyether diol shown in Structure (II);

(b) a polyisocyanate component comprising a diisocyanate;

(c) a ionic functional component in an amount required to maintain a stable dispersion of the polyurethane in water, wherein the ionic functional component comprises isocyanate and/or isocyanate-reactive functionality and

(d) a nonionic primary or secondary amine to produce the urea termination.

The key features of the polyurethane are the polyether diol and the primary or secondary amine which results in the urea termination. Without being bound by theory, these polyurethanes perform better when added as a free add to ink jet ink, pharmaceutical formulations and the like or act as dispersants for pigments etc. Also, the polyether diol/urea termination combination seems to produce a relatively pure polyurethane that does not have contamination and/or extensive crosslinking that can lead to poorer performance with pigments and the like.

It should be understood that the process used to prepare the polyurethane generally results in a urea-terminated polyurethane polymer of the above structure being present in the final product. However, it is understood that the final product will typically be a mixture of products, of which a portion is the above urea terminated polyurethane polymer, the other portion being a normal distribution of other polymer products and may contain varying ratios of unreacted monomers. The heterogeneity of the resultant polymer will depend on the reactants selected and reactant conditions chosen, as will be apparent to those skilled in the art.

### Polyether Diol Component

As indicated above, the polyether diol component comprises at least about 50 wt % of the polyether diol shown as Z₁ Structure (II) more preferably at least about 66 wt % of the polyether diol shown in Structure (II) still more preferably at least about 75 wt % of the polyether diol shown in Structure (II) and even still more preferably at least about 90 wt % of the polyether diol shown in Structure (II) based on the weight of the polyether diol component.

In one embodiment, the polyether diol shown in (Structure (II) may be blended with other oligomeric and/or polymer polyfunctional isocyanate-reactive compounds such as, for example, polyols, polyamines, polythiols, polythioamines, polyhydroxythiols and polyhydroxylamines. When blended, it is preferred to use di-functional components and, more preferably, one or more diols including, for example, polyether diols, polyester diols, polycarbonate diols, polyacrylate diols, polyolefin diols and silicone diols.

The polyether diol shown in Structure (II) are oligomers and polymers in which at least 50% of the repeating units have 3 to 12 methylene groups in the ether chemical groups. More preferably from about 75% to 100%, still more preferably from about 90% to 100%, and even more preferably from about 99% to 100%, of the repeating units are 3 to 12 methylene groups in the ether chemical groups (in Structure (II) m=3-12). The preferable number of methylene groups is 3 or 4.

The polyether diol shown in Structure (II) can be prepared by polycondensation of monomers comprising alpha, omega diols where m=3-12. Thus resulting in polymers or copolymers containing the structural linkage shown above. As indicated above, at least 50% of the repeating units are 3 to 12 methylene ether units.

The oligomers and polymers based on the polyether diol {where p is greater than 1} shown in Structure (II), have from 2 to about 50 of the ether diol repeating groups shown in Structure (II); more preferable about 5 to about 20 of the ether diol repeating groups shown in Structure (II), where p denotes the number of repeating groups. In structure (II) R₅ and R₆ are hydrogen, alkyl, substituted alkyl, aryl; where the R₅ and R₆ are the same or different with each substituted methylene group and where R₅ and R₆ can be joined to form a cyclic structure. The substituted alkyl group preferably does not contain isocyanate reactive groups except as described below where a limited amount of trihydric alcohols can be allowed. In general, the substituted alkyls are intended to be inert during the polyurethane preparation.

In addition to the 3 to 12 methylene ether units, lesser amounts of other units, such as other polyalkylene ether repeating units derived from ethylene oxide and propylene oxide may be present. The amount of the ethylene glycols and 1,2-propylene glycols which are derived from epoxides such as ethylene oxide, propylene oxide, butylene oxide, etc are limited to less than 10% of the total polyether diol weight. A preferred polyether diol is derived from polytrimethylene ether glycol (“PO3G”). The employed PO3G may be obtained by any of the various well known chemical routes or by biochemical transformation routes. The description of this biochemically obtained 1,3-propanediol can be found in co-owned and co-pending U.S. patent application Ser. No. 11/782,098 (filed Jul. 24, 2007), the disclosure of which is incorporated by reference herein for all purposes as if fully set forth

The starting material for making will depend on the desired polyether diol availability of starting materials, catalysts, equipment, etc., and comprises “1,3 to 12-diol reactant.” By “1,3 to 12-diol reactant” is meant 1,3 to -12-diol, and oligomers and prepolymers of 1,3 to 12-diol preferably having a degree of polymerization of 2 to 50, and mixtures thereof. In some instances, it may be desirable to use up to 10% or more of low molecular weight oligomers where they are available. Thus, preferably the starting material comprises 1,3 to 12-diol and the dimer and trimer thereof. A particularly preferred starting material is comprised of about 90% by weight or more 1,3 to 12-diol, and more preferably 99% by weight or more 1,3 to 12-diol, based on the weight of the 1,3 to -12-diol reactant.

As indicated above, the polyether diol shown in Structure (II) may contain lesser amounts of other polyalkylene ether repeating units in addition to the 3 to 12 methylene ether units. The monomers for use in preparing poly(3 to 12)methylene ether glycol can, therefore, contain up to 50% by weight (preferably about 20 wt % or less, more preferably about 10 wt % or less, and still more preferably about 2 wt % or less), of comonomer diols in addition to the 1,3-propanediol reactant. Comonomer diols that are suitable for use in the process include aliphatic diols, for example, ethylene glycol, 1,6-hexanediol, 1,7-heptanediol, 1,8-octanediol, 1,9-nonanediol, 1,10-decanediol, 1,12-dodecanediol, 3,3,4,4,5,5-hexafluoro-1,5-pentanediol, 2,2,3,3,4,4,5,5-octafluoro-1,6-hexanediol, and 3,3,4,4,5,5,6,6,7,7,8,8,9,9,10,10-hexadecafluoro-1,12-dodecanediol; cycloaliphatic diols, for example, 1,4-cyclohexanediol, 1,4-cyclohexanedimethanol and isosorbide; and polyhydroxy compounds, for example, glycerol, trimethylolpropane, and pentaerythritol. The polyether diol shown in Structure (II) useful in practicing this invention can contain small amounts of other repeat units, for example, from aliphatic or aromatic diacids or diesters, such as described in U.S. Pat. No. 6,608,168 (the disclosure of which is incorporated by reference herein for all purposes as if fully set forth). This type of the polyether diol shown in Structure (II) can also be called a “random polymethylene ether ester”, and can be prepared by polycondensation of 1,3 to 12 diol reactant and about 10 to about 0.1 mole % of aliphatic or aromatic diacid or esters thereof, such as terephthalic acid, isophthalic acid, bibenzoic acid, naphthalic acid, bis(p-carboxyphenyl)methane, 1,5-naphthalene dicarboxylic acid, 2,6-naphthalene dicarboxylic acid, 2,7-naphthalene dicarboxylic acid, 4,4′-sulfonyl dibenzoic acid, p-(hydroxyethoxy)benzoic acid, and combinations thereof, and dimethyl terephthalate, bibenzoate, isophthlate, naphthalate and phthalate; and combinations thereof. Of these, terephthalic acid, dimethyl terephthalate and dimethyl isophthalate are preferred . . . .

The preferred polyether diol shown in Structure (II) for use in the invention have a number average molecular weight (Mₙ) in the range of about 200 to about 5000, and more preferably from about 240 to about 3600. Blends of the polyether diol shown in Structure (II) can also be used. For example, the polyether diol shown in Structure (II) can comprise a blend of a higher and a lower molecular weight polyether diol shown in Structure (II) preferably wherein the higher molecular weight polyether diol shown in Structure (II) has a number average molecular weight of from about 1000 to about 5000, and the lower molecular weight polyether diol shown in Structure (II) has a number average molecular weight of from about 200 to about 750. The Mₙ of the blended polyether diol shown in Structure (II) will preferably still be in the range of from about 250 to about 3600. The polyether diol shown in Structure (II) preferred for use herein are typically polydisperse polymers having a polydispersity (i.e. M_{w}/Mₙ) of preferably from about 1.0 to about 2.2, more preferably from about 1.2 to about 2.2, and still more preferably from about 1.5 to about 2.1. The polydispersity can be adjusted by using blends polyether diol shown in Structure (II).

The polyether diol shown in Structure (II) for use in the present invention preferably have a color value of less than about 100 APHA, and more preferably less than about 50 APHA.

### Other Isocyanate-Reactive Components

As indicated above, the polyether diol shown in Structure (II) may be blended with up to about 30 wt % of other polyfunctional isocyanate-reactive components, most notably oligomeric and/or polymeric polyols, more preferably up to about 20 wt %.

Suitable other diols contain at least two hydroxyl groups, and preferably have a molecular weight of from about 60 to about 6000. Of these, the polymeric other diols are best defined by the number average molecular weight, and can range from about 200 to about 6000, preferably from about 800 to about 3000, and more preferably from about 1000 to about 2500. The molecular weights can be determined by hydroxyl group analysis (OH number).

Examples of polymeric polyols include polyesters, polyethers, polycarbonates, polyacetals, poly(meth)acrylates, polyester amides, polythioethers and mixed polymers such as a polyester-polycarbonates where both ester and carbonate linkages are found in the same polymer. A combination of these polymers can also be used. For examples, a polyester polyol and a poly (meth)acrylate polyol may be used in the same polyurethane synthesis.

Suitable polyester polyols include reaction products of polyhydric, preferably dihydric alcohols to which trihydric alcohols may optionally be added, and polybasic (preferably dibasic) carboxylic acids. Trihydic alcohols are limited to at most about 2 weight % such that some branching can occur but no significant crosslinking would occur, and may be used in cases in which modest branching of the NCO prepolymer or polyurethane is desired. Instead of these polycarboxylic acids, the corresponding carboxylic acid anhydrides or polycarboxylic acid esters of lower alcohols or mixtures thereof may be used for preparing the polyesters.

The polycarboxylic acids may be aliphatic, cycloaliphatic, aromatic and/or heterocyclic or mixtures thereof and they may be substituted, for example, by halogen atoms, and/or unsaturated. The following are mentioned as examples: succinic acid; adipic acid; suberic acid; azelaic acid; sebacic acid; 1,12-dodecyldioic acid; phthalic acid; isophthalic acid; trimellitic acid; phthalic acid anhydride; tetrahydrophthalic acid anhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate.

Preferable polyester diols for blending with the polyol shown in Structure (II) are hydroxyl terminated poly(butylene adipate), poly(butylene succinate), poly(ethylene adipate), poly(1,2-propylene adipate), poly(trimethylene adipate), poly(trimethylene succinate), polylactic acid ester diol and polycaprolactone diol. Other hydroxyl terminated polyester diols are copolyethers comprising repeat units derived from a diol and a sulfonated dicarboxylic acid and prepared as described in U.S. Pat. No. 6,316,586 (the disclosure of which is incorporated by reference herein for all purposes as if fully set forth). The preferred sulfonated dicarboxylic acid is 5-sulfo-isophthalic acid, and the preferred diol is 1,3-propanediol.

Suitable polyether polyols are obtained in a known manner by the reaction of starting compounds that contain reactive hydrogen atoms with alkylene oxides such as ethylene oxide, propylene oxide, butylene oxide, styrene oxide, tetrahydrofuran, epichlorohydrin or mixtures of these. It is preferred that the polyethers do not contain more than about 10% by weight of ethylene oxide units. More preferably, polyethers obtained without the addition of ethylene oxide are used. Suitable starting compounds containing reactive hydrogen atoms include the polyhydric alcohols set forth for preparing the polyester polyols and, in addition, water, methanol, ethanol, 1,2,6-hexane triol, 1,2,4-butane triol, trimethylol ethane, pentaerythritol, mannitol, sorbitol, methyl glycoside, sucrose, phenol, isononyl phenol, resorcinol, hydroquinone, 1,1,1- and 1,1,2-tris-(hydroxylphenyl)-ethane, dimethylolpropionic acid or dimethylolbutanoic acid.

Polyethers that have been obtained by the reaction of starting compounds containing amine compounds can also be used. Examples of these polyethers as well as suitable polyhydroxy polyacetals, polyhydroxy polyacrylates, polyhydroxy polyester amides, polyhydroxy polyamides and polyhydroxy polythioethers, are disclosed in U.S. Pat. No. 4,701,480 (the disclosure of which is incorporated by reference herein for all purposes as if fully set forth).

Polycarbonates containing hydroxyl groups include those known, per se, such as the products obtained from the reaction of diols such as 1,3-propanediol, 1,4-butanediol and/or 1,6-hexanediol, diethylene glycol, triethylene glycol or tetraethylene glycol, higher polyether diols with phosgene, diarylcarbonates such as diphenylcarbonate, dialkylcarbonates such as diethylcarbonate or with cyclic carbonates such as ethylene or propylene carbonate. Also suitable are polyester carbonates obtained from the above-mentioned polyesters or polylactones with phosgene, diaryl carbonates, dialkyl carbonates or cyclic carbonates.

Polycarbonate diols for blending are preferably selected from the group consisting of polyethylene carbonate diol, polytrimethylene carbonate diol, polybutylene carbonate diol and polyhexylene carbonate.

Poly(meth)acrylates containing hydroxyl groups include those common in the art of addition polymerization such as cationic, anionic and radical polymerization and the like. Examples are alpha-omega diols. An example of these type of diols are those which are prepared by a “living” or “control” or chain transfer polymerization processes which enables the placement of one hydroxyl group at or near the termini of the polymer. U.S. Pat. No. 6,248,839 and U.S. Pat. No. 5,990,245 (the disclosures of which are incorporated by reference herein for all purposes as if fully set forth) have examples of protocol for making terminal diols. Other di-NCO reactive poly(meth)acrylate terminal polymers can be used. An example would be end groups other than hydroxyl such as amino or thiol, and may also include mixed end groups with hydroxyl.

Polyolefin diols are available from Shell as KRATON LIQUID L and Mitsubishi Chemical as POLYTAIL H.

Silicone glycols are well known, and representative examples are described in U.S. Pat. No. 4,647,643, the disclosure of which is incorporated by reference herein for all purposes as if fully set forth.

Other optional compounds for preparing the NCO prepolymer include lower molecular weight, at least difunctional NCO-reactive compounds having an average molecular weight of up to about 400. Examples include the dihydric and higher functional alcohols, which have previously been described for the preparation of the polyester polyols and polyether polyols.

In addition to the above-mentioned components, which are preferably difunctional in the isocyanate polyaddition reaction, mono-functional and even small portions of trifunctional and higher functional components generally known in polyurethane chemistry, such as trimethylolpropane or 4-isocyanantomethyl-1,8-octamethylene diisocyanate, may be used in cases in which branching of the NCO prepolymer or polyurethane is desired.

It is, however, preferred that the NCO-functional prepolymers should be substantially linear, and this may be achieved by maintaining the average functionality of the prepolymer starting components at or below 2:1.

Similar NCO reactive materials can be used as described for hydroxy containing compounds and polymers, but which contain other NCO reactive groups. Examples would be dithiols, diamines, thioamines and even hydroxythiols and hydroxylamines. These can either be compounds or polymers with the molecular weights or number average molecular weights as described for the polyols.

Chain Termination Reactant.

The terminating agent is a primary or secondary monoamine which is added to make the urea termination. In Structure (I) the terminating agent is shown as R₃(R₄)N— substituent on the polyurethane. The substitution pattern for R₃ and R₄ include hydrogen, alkyl, a substituted/branched alkyl, isocyanate reactive where the substituent can be a isocyanate reactive group selected from hydroxyl, carboxyl, mercapto, amido and other ones which have less isocyanate reactivity than primary or secondary amine. At least one of the R₃ and R₄ must be other than hydrogen.

The amount of chain terminator employed should be approximately equivalent to the free isocyanate groups in the prepolymer. The ratio of active hydrogens in the chain terminator to isocyanate groups in the prepolymer preferably being in the range from about 1.0:1 to about 1.2:1, more preferably from about 1.0:1.1 to about 1.1:1, and still more preferably from about 1.0:1.05 to about 1.1:1, on an equivalent basis. Although any isocyanate groups that are not terminated with an amine can react with water the ratios of chain termination to isocyanate group is chosen to assure a urea termination. Amine termination of the polyurethane is avoided by the choice and amount of chain terminating agent leading to a urea terminated polyether diol polyurethane which has better molecular weight control and better properties when freely added to formulations and as a particle dispersant.

Any primary or secondary monoamines substituted with less isocyanate reactive groups may be used as chain terminators. Aliphatic primary or secondary monoamines are preferred. Example of monoamines useful as chain terminators include but are not restricted to butylamine, hexylamine, 2-ethylhexyl amine, dodecyl amine, diisopropanol amine, stearyl amine, dibutyl amine, dinonyl amine, bis(2-ethylhexyl)amine, diethylamine, bis(methoxyethyl)amine, N-methylstearyl amine and N-methyl aniline. A more preferred isocyanate reactive chain terminator is bis(methoxyethyl)amine. The bis(methoxyethyl)amine is part of a preferred class of urea terminating reactant where the substituents are non reactive in the isocyanate chemistry, but are nonionic hydrophilic groups. This nonionic hydrophilic group preferably provides the urea terminated polyether diol polyurethane with more water compatible.

Less isocyanate reactive groups could be hydroxyl, carboxyl, amide and mercapto. Example of monoamines useful as chain terminators include but are not restricted to monoethanolamine, 3-amino-1-propanol, isopropanolamine, N-ethylethanolamine, diisopropanolamine, 6-aminocaproic acid, 8-aminocaprylic acid, 3-aminoadipic acid, and lysine. Chain terminating agents may include those with two less isocyanate reactive groups such as glutamine. A preferred isocyanate reactive chain terminator is diethanolamine. The diethanolamine is part of a preferred class of urea terminating reactant where the substituents are hydroxyl functionalities which can provide improved pigment wetting. The relative reactivity of the amine versus the less isocyanate reactive group and the mole ratios of NCO and the chain terminating amine produce the urea terminated polyurethane.

The urea content of the urea-terminated polyurethane in weight percent of the polyurethane is determined by dividing the mass of chain terminator by the sum of the other polyurethane components including the chain terminating agent. The urea content is from about 2 wt % to about 14 wt %. The urea content is preferably from about 2.5 wt % to about 10.5 wt % of the polyurethane.

### Polyisocyanate Component

Suitable polyisocyanates are those that contain either aromatic, cycloaliphatic or aliphatic groups bound to the isocyanate groups. Mixtures of these compounds may also be used. Preferred are compounds with isocyanates bound to a cycloaliphatic or aliphatic moieties. If aromatic isocyanates are used, cycloaliphatic or aliphatic isocyanates are preferably present as well. R₁ can be preferably substituted with aliphatic groups.

Diisocyanates are preferred, and any diisocyanate useful in preparing polyurethanes and/or polyurethane-ureas from polyether glycols, diisocyanates and diols or amine can be used in this invention.

Examples of suitable diisocyanates include, but are not limited to, 2,4-toluene diisocyanate (TDI); 2,6-toluene diisocyanate; trimethyl hexamethylene diisocyanate (TMDI); 4,4′-diphenylmethane diisocyanate (MDI); 4,4′-dicyclohexylmethane diisocyanate (H₁₂MDI); 3,3′-dimethyl-4,4′-biphenyl diisocyanate (TODI); Dodecane diisocyanate (C₁₂DI); m-tetramethylene xylylene diisocyanate (TMXDI); 1,4-benzene diisocyanate; trans-cyclohexane-1,4-diisocyanate; 1,5-naphthalene diisocyanate (NDI); 1,6-hexamethylene diisocyanate (HDI); 4,6-xylyene diisocyanate; isophorone diisocyanate (IPDI); and combinations thereof. IPDI and TMXDI are preferred.

Small amounts, preferably less than about 3 wt % based on the weight of the diisocyanate, of monoisocyanates or polyisocyanates can be used in mixture with the diisocyanate. Examples of useful monoisocyanates include alkyl isocyanates such as octadecyl isocyanate and aryl isocyanates such as phenyl isocyanate. Example of a polyisocyanate are triisocyanatotoluene HDI trimer (Desmodur 3300), and polymeric MDI (Mondur MR and MRS).

### Ionic Reactants

The hydrophilic reactant contains ionic and/or ionizable groups (potentially ionic groups). Preferably, these reactants will contain one or two, more preferably two, isocyanate reactive groups, as well as at least one ionic or ionizable group. In the structural description of the urea terminated polyether polyurethane described herein the reactant containing the ionic group is designated as Z₂.

Examples of ionic dispersing groups include carboxylate groups (—COOM), phosphate groups (—OPO₃M₂), phosphonate groups (—PO₃M₂), sulfonate groups (—SO₃M), quaternary ammonium groups (—NR₃Y, wherein Y is a monovalent anion such as chlorine or hydroxyl), or any other effective ionic group. M is a cation such as a monovalent metal ion (e.g., Na⁺, K⁺, Li⁺, etc.), H⁺, NR₄⁺, and each R can be independently an alkyl, aralkyl, aryl, or hydrogen. These ionic dispersing groups are typically located pendant from the polyurethane backbone.

The ionizable groups in general correspond to the ionic groups, except they are in the acid (such as carboxyl —COOH) or base (such as primary, secondary or tertiary amine —NH₂, —NRH, or —NR₂) form. The ionizable groups are such that they are readily converted to their ionic form during the dispersion/polymer preparation process as discussed below.

The ionic or potentially ionic groups are chemically incorporated into the polyurethane in an amount to provide an ionic group content (with neutralization as needed) sufficient to render the polyurethane dispersible in the aqueous medium of the dispersion. Typical ionic group content will range from about 10 up to about 210 milliequivalents (meq), preferably from about 20 to about 140 meq., per 100 g of polyurethane.

Suitable compounds for incorporating these groups include (1) monoisocyanates or diisocyanates which contain ionic and/or ionizable groups, and (2) compounds which contain both isocyanate reactive groups and ionic and/or ionizable groups. In the context of this disclosure, the term “isocyanate reactive groups” is taken to include groups well known to those of ordinary skill in the relevant art to react with isocyanates, and preferably hydroxyl, primary amino and secondary amino groups.

Examples of isocyanates that contain ionic or potentially ionic groups are sulfonated toluene diisocyanate and sulfonated diphenylmethanediisocyanate.

With respect to compounds which contain isocyanate reactive groups and ionic or potentially ionic groups, the isocyanate reactive groups are typically amino and hydroxyl groups. The potentially ionic groups or their corresponding ionic groups may be cationic or anionic, although the anionic groups are preferred. Preferred examples of anionic groups include carboxylate and sulfonate groups. Preferred examples of cationic groups include quaternary ammonium groups and sulfonium groups.

The neutralizing agents for converting the ionizable groups to ionic groups are described in the preceding incorporated publications, and are also discussed hereinafter. Within the context of this invention, the term “neutralizing agents” is meant to embrace all types of agents that are useful for converting ionizable groups to the more hydrophilic ionic (salt) groups.

In the case of anionic group substitution, the groups can be carboxylic acid groups, carboxylate groups, sulphonic acid groups, sulphonate groups, phosphoric acid groups and phosphonate groups, The acid salts are formed by neutralizing the corresponding acid groups either prior to, during or after formation of the NCO prepolymer, preferably after formation of the NCO prepolymer.

Suitable compounds for incorporating carboxyl groups are described in U.S. Pat. No. 3,479,310, U.S. Pat. No. 4,108,814 and U.S. Pat. No. 4,408,008, the disclosures of which are incorporated by reference herein for all purposes as if fully set forth. The neutralizing agents for converting the carboxylic acid groups to carboxylate salt groups are described in the preceding incorporated publications, and are also discussed hereinafter. Within the context of this invention, the term “neutralizing agents” is meant to embrace all types of agents that are useful for converting carboxylic acid groups to the more hydrophilic carboxylate salt groups. In like manner, sulphonic acid groups, sulphonate groups, phosphoric acid groups, and phosphonate groups can be neutralized with similar compounds to their more hydrophilic salt form.

Examples of carboxylic group-containing compounds are the hydroxy-carboxylic acids corresponding to the structure (HO)ₓQ(COOH)_{y} wherein Q represents a straight or branched, hydrocarbon radical containing 1 to 12 carbon atoms, x is 1 or 2 (preferably 2), and y is 1 to 3 (preferably 1 or 2).

Examples of these hydroxy-carboxylic acids include citric acid, tartaric acid and hydroxypivalic acid.

Especially preferred acids are those of the above-mentioned structure wherein x=2 and y=1. These dihydroxy alkanoic acids are described in U.S. Pat. No. 3,412,054, the disclosure of which is incorporated by reference herein for all purposes as if fully set forth. Especially preferred dihydroxy alkanoic acids are the alpha,alpha-dimethylol alkanoic acids represented by the Structure (III):

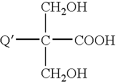

wherein Q′ is hydrogen or an alkyl group containing 1 to 8 carbon atoms. The most preferred compound is alpha, alpha-dimethylol propionic acid, i.e., wherein Q′ is methyl in the above formula. These dihydroxy alkanoic acids are described in U.S. Pat. No. 3,412,054, the disclosure of which is incorporated by reference herein for all purposes as if fully set forth. The preferred group of dihydroxy alkanoic acids are the α,α-dimethylol alkanoic acids represented by the structure R⁷C—(CH₂OH)₂—COOH, wherein R⁷ is hydrogen or an alkyl group containing 1 to 8 carbon atoms. Examples of these ionizable diols include but are not limited to dimethylolacetic acid, 2,2′-dimethylolbutanoic acid, 2,2′-dimethylolpropionic acid, and 2,2′-dimethylolbutyric acid. The most preferred dihydroxy alkanoic acids is 2,2′-dimethylolpropionic acid (“DMPA”). Suitable carboxylates also include H₂N—(CH₂)₄—CH(CO₂H)—NH₂, and H₂N—CH₂—CH₂—NH—CH₂—CH₂—CO₂Na

When the ionic stabilizing groups are acids, the acid groups are incorporated in an amount sufficient to provide an acid group content for the urea-terminated polyurethane, known by those skilled in the art as acid number (mg KOH per gram solid polymer), of at least about 6, preferably at least about 10 milligrams KOH per 1.0 gram of polyurethane and even more preferred 20 milligrams KOH per 1.0 gram of polyurethane, The upper limit for the acid number (AN) is about 120, and preferably about 90.

These ionic groups are formed by neutralizing the corresponding potentially ionic or ionizable groups either prior to, during or after forming the polyurethane. When potentially ionic groups are neutralized prior to forming the polyurethane, the ionic groups are incorporated directly. When neutralization is preformed subsequent to forming the polyurethane, potentially ionic groups are incorporated.

Suitable compounds for incorporating the previously discussed carboxylate, sulfonate and quaternary nitrogen groups are described in U.S. Pat. No. 3,479,310, U.S. Pat. No. 4,303,774 and U.S. Pat. No. 4,108,814, the disclosures of which are incorporated by reference herein for all purposes as if fully set forth.

Suitable compounds for incorporating tertiary sulfonium groups are described in U.S. Pat. No. 3,419,533, the disclosure of which is incorporated by reference herein for all purposes as if fully set froth. The neutralizing agents for converting the potentially ionic groups to ionic groups are also described in those patents. Within the context of this disclosure, the term “neutralizing agents” is meant to embrace all types of agents which are useful for converting potentially ionic or ionizable groups to ionic groups. Accordingly, this term also embraces quaternizing agents and alkylating agents.

The preferred sulfonate groups for incorporation into the polyurethanes are the diol sulfonates as disclosed in previously incorporated U.S. Pat. No. 4,108,814. Suitable diol sulfonate compounds also include hydroxyl terminated copolyethers comprising repeat units derived from a diol and a sulfonated dicarboxylic acid and prepared as described in previously incorporated U.S. Pat. No. 6,316,586. The preferred sulfonated dicarboxylic acid is 5-sulfo-isophthalic acid, and the preferred diol is 1,3-propanediol.

Suitable sulfonates also include H₂N—CH₂—CH₂—NH—(CH₂)ᵣ—SO₃Na, where r=2 or 3; and HO—CH₂—CH₂—C(SO₃Na)—CH₂—OH. The preferred carboxylate groups for incorporation are derived from hydroxy-carboxylic acids of the general structure ((HO)ₓR⁸(COOH)_{y}, wherein R⁸ represents a straight or branched hydrocarbon radical containing 1 to 12 carbon atoms, and x and y each independently represents values from 1 to 3. Examples of these hydroxy-carboxylic acids include citric acid and tartaric acid.

In addition to the foregoing, cationic centers such as tertiary amines with one alkyl and two alkylol groups may also be used as the ionic or ionizable group.

When amines are used as the neutralizing agent, the chain terminating reaction producing the urea termination is preferably completed prior to addition of the neutralizing agent that can also behave as an isocyanate reactive group.

In order to convert the preferred potential anionic groups to anionic groups either before, during or after their incorporation into the prepolymers, either volatile or nonvolatile basic materials may be used to form the counterions of the anionic groups. Volatile bases are those wherein at least about 90% of the base used to form the counterion of the anionic group volatilizes under the conditions used to remove water from the aqueous polyurethane dispersions. Nonvolatile basic materials are those wherein at least about 90% of the base does not volatilize under the conditions used to remove water from the aqueous polyurethane dispersions.

Suitable volatile basic organic compounds for neutralizing the potential anionic groups are the primary, secondary or tertiary amines. Of these the trialkyl-substituted tertiary amines are preferred. Examples of these amines are trimethyl amine, triethyl amine, triisopropyl amine, tributyl amine, N,N-dimethyl-cyclohexyl amine, N,N-dimethylstearyl amine, N,N-dimethylaniline, N-methylmorpholine, N-ethylmorpholine, N-methylpiperazine, N-methylpyrrolidine, N-methylpiperidine, N,N-dimethyl-ethanol amine, N,N-diethyl-ethanol amine, triethanolamine, N-methyldiethanol amine, dimethylaminopropanol, 2-methoxyethyidimethyl amine, N-hydroxyethylpiperazine, 2-(2-dimethylaminoethoxy)-ethanol and 5-diethylamino-2-pentanone.

Suitable nonvolatile basic materials include monovalent metals, preferably alkali metal, more preferably lithium, sodium and potassium and most preferably sodium, hydrides, hydroxides, carbonates or bicarbonates. When an acid-containing diol, for example, is used as the ionic group, a relatively mild inorganic base such as NaHCO₃, Na₂(CO₃), NaAc (where Ac represents acetate), NaH₂PO₄ and the like will assist in improving the dispersion. These inorganic bases are relatively low in odor, and also tend not to be skin irritants.

When the potential cationic or anionic groups of the polyurethane are neutralized, they provide hydrophilicity to the polymer and facilitating the formation of a stable aqueous polyurethane dispersion. The neutralization steps may be conducted (1) prior to polyurethane formation by treating the component containing the potentially ionic group(s), or (2) after polyurethane formation, but prior to dispersing the polyurethane. The reaction between the neutralizing agent and the potential anionic groups may be conducted between about 20° C. and about 150° C., but is normally conducted at temperatures below about 100° C., preferably between about 30° C. and about 80° C., and more preferably between about 50° C. and about 70° C., with agitation of the reaction mixture. The ionic or potentially ionic group may be used in amount of about 2 to about 20 percent by weight solids.

The isocyanate reactive ionic reactants will preferably contain one or two, more preferably two, isocyanate reactive groups such as amino or hydroxyl groups, as well as at least one ionic or ionizable group such as carboxyl, sulfonate and tertiary ammonium salts. A preferred ionic or ionizable group is carboxyl.

### Polyurethane and Dispersion Preparation

The process of preparing the dispersions of the invention begins with preparation of the polyurethane, which can be prepared by mixture or stepwise methods. The preferred physical form of the polyurethane is as a dispersion, and as such can be easily added to formulations as a freely added polyurethane. However, these urea-terminated polyether polyurethanes can behave as a dispersant for a particle, such as a pigment. In this case, the polyurethane is either 1) utilized as a dissolved polyurethane in a compatible solvent where the initial polyurethane/particle mixture is prepared and then processed using dispersion equipment to produce the polyurethane dispersed particle; or 2) the polyurethane dispersion and the particle dispersed are mixed in a compatible solvent system which, in turn is processed using dispersion equipment to produce the polyurethane dispersed particle. The urea terminated polyether polyurethane of the present invention can function as a dispersed polyurethane and a polyurethane dispersant.

In the mixture process for preparing the urea terminated polyurethane, the isocyanate terminated polyurethane is prepared by mixing the polyol of Structure (II), the ionic reactant, up to 50% other diols, and solvent, and then adding diisocyanate to the mixture. This reaction is conducted at from about 40° C. to about 100° C., and more preferably from about 50° C. to about 90° C. The preferred ratio of isocyanate to isocyanate reactive groups is from about 1.3:1 to about 1.05:1, and more preferably from about 1.25:1 to about 1.1:1. This isocyanate terminated polyurethane is often called a polyurethane prepolymer prior to the reaction with the chain terminating agent. When the targeted percent isocyanate is reached, then the primary or secondary amine chain terminator is added, and then base or acid is added to neutralize ionizable moieties incorporated from the ionizable reagent. The polyurethane solution is then converted to an aqueous polyurethane dispersion via the addition of water under high shear. If present, the volatile solvent can be distilled under reduced pressure. The steps of adding the chain terminating agent, adding the neutralizing acid or base and adding the water can be done in any convenient order.

If some cases, addition of neutralization agent, preferably tertiary amines, may be beneficial added during early stages of the polyurethane synthesis. Alternately, advantages may be achieved via the addition of the neutralization agent, preferably alkali base, simultaneously along with the water of inversion at high shear.

In the stepwise method, isocyanate terminated polyurethane is prepared by dissolving the ionic reactant in solvent, and then adding diisocyanate to the mixture. Once the initial percent isocyanate target is reached, the polyol component is added. This reaction is conducted at from about 40° C. to about 100° C., and more preferably from about 50° C. to about 90° C. The preferred ratio of isocyanate to isocyanate reactive groups is from about 1.3:1 to about 1.05:1, and more preferably from about 1.25:1 to about 1.1:1. Alternately, the polyether polyols and up to 50% other diols may be reacted in the first step, and the ionic reactant may be added after the initial percent isocyanate target is reached. When the final targeted percent isocyanate for the polyurethane prepolymer is reached, then the chain terminator is added, and then base or acid is added to neutralize ionizable moieties incorporated from the ionizable reagent. The polyurethane solution is then converted to an aqueous polyurethane dispersion via the addition of water under high shear. If present, the volatile solvent is distilled under reduced pressure.

In all polyurethane reaction schemes if the neutralization reactant has isocyanate reaction capability, (for example an alcohol, primary amine or secondary amine) it cannot be added prior to the chain terminating, urea forming amine. If the neutralization agent can function as a chain terminating reactant according to Structure (I), then it must be added after all of the other isocyanate reactive groups have been reacted.

Catalysts are not necessary to prepare the polyurethanes, but may provide advantages in their manufacture. The catalysts most widely used are tertiary amines and organo-tin compounds such as stannous octoate, dibutyltin dioctoate, dibutyltin dilaurate.

Preparation of the polyurethane for subsequent conversion to a dispersion is facilitated by using solvent. Suitable solvents are those that are miscible with water and inert to isocyanates and other reactants utilized in forming the polyurethanes. If it is desired to prepare a solvent-free dispersion, then it is preferable to use a solvent with a high enough volatility to allow removal by distillation. However, polymerizable vinyl compounds may also be used as solvents, followed by free radical polymerization after inversion, thus forming a polyurethane acrylic hybrid dispersion. Typical solvents useful in the practice of the invention are acetone, methyl ethyl ketone, toluene, and N-methyl pyrollidone. Preferably the amount of solvent used in the reaction will be from about 10% to about 50%, more preferably from about 20% to about 40% of the weight. Alternatively, the polyurethane can be prepared in a melt with less than 5% solvent.

Process conditions for preparing the NCO containing prepolymers have been discussed in the publications previously noted. The finished NCO-containing prepolymer should have a isocyanate content of about 1 to about 20%, preferably about 1 to about 10% by weight, based on the weight of prepolymer solids.

Mixtures of compounds and/or polymers having mixed NCO reactive groups are also possible.

The process conditions used for preparing the urea-terminated ether type polyurethane of the present invention generally results in a polyurethane polymer of Structure I being present in the final product. However, it is understood that the final product will typically be a mixture of products, of which a portion is the desired polyurethane polymer, the other portion being a normal distribution of other polymer products and may contain varying ratios of unreacted monomers. The heterogeneity of the resultant polymer will depend on the reactants selected and reactant conditions chosen, as will be apparent to those skilled in the art.

### Polyurethane Dispersion Preparation

In accordance with the present invention the term “aqueous polyurethane dispersion” refers to aqueous dispersions of polymers containing urethane groups, as that term is understood by those of ordinary skill in the art. These polymers also incorporate hydrophilic functionality to the extent required to maintain a stable dispersion of the polymer in water. The compositions of the invention are aqueous dispersions that comprise a continuous phase comprising water, and a dispersed phase comprising polyurethane.

Following formation of the desired polyurethane dispersion, preferably in the presence of solvent as discussed above, the pH may be adjusted typically pH about 7 to 9, if necessary, to insure conversion of ionizable groups to ionic groups. For example, if the preferred dimethylolpropionic acid is the ionic or ionizable ingredient used in making the polyurethane, then sufficient aqueous base is added to convert the carboxyl groups to carboxylate anions.

Conversion to the aqueous dispersion is completed by addition of water. If desired, solvent can then be removed partially or substantially by distillation under reduced pressure. The final product is a stable, aqueous polyurethane dispersion having a solids content of up to about 60% by weight, preferably from about 10% to about 60% by weight, and more preferably from about 20% to about 45% by weight. However, it is always possible to dilute the dispersions to any minimum solids content desired. The solids content of the resulting dispersion may be determined by drying the sample in an oven at 150° C. for 2 hours and comparing the weights before and after drying. The particle size is generally below about 1.0 micron, and preferably between about 0.01 to about 0.5 micron. The average particle size should be less than about 0.5 micron, and preferably between about 0.01 to about 0.3 micron. The small particle size enhances the stability of the dispersed particles

Fillers, plasticizers, pigments, carbon black, silica sols, other polymer dispersions and the known leveling agents, wetting agents, antifoaming agents, stabilizers, and other additives known for the desired end use, may also be incorporated into the dispersions.

### Neutralization

In order to have a stable dispersion, a sufficient amount of the ionic groups (if present) must be neutralized so that, when combined with the optional hydrophilic ethylene oxide and other alkenyl oxide units and optional external emulsifiers, the resulting polyurethane will remain stably dispersed in the aqueous medium. Generally, at least about 70%, preferably at least about 80%, of the acid groups are neutralized to the corresponding carboxylate salt groups. Alternatively, cationic groups in the polyurethane can be quaternary ammonium groups (—NR₃Y, wherein Y is a monovalent anion such as chlorine or hydroxyl).

Suitable neutralizing agents for converting the acid groups to salt groups include tertiary amines, alkali metal cations and ammonia. Examples of these neutralizing agents are disclosed in previously incorporated U.S. Pat. No. 4,701,480, as well as U.S. Pat. No. 4,501,852 (the disclosure of which is incorporated by reference herein for all purposes as if fully set forth). Preferred neutralizing agents are the trialkyl-substituted tertiary amines, such as triethyl amine, tripropyl amine, dimethylcyclohexyl amine, dimethylethanol amine, and triethanol amine and dimethylethyl amine. Substituted amines are also useful neutralizing groups such as diethyl ethanol amine or diethanol methyl amine.

Neutralization may take place at any point in the process. Typical procedures include at least some neutralization of the prepolymer, which is then chain extended/terminated in water in the presence of additional neutralizing agent.

The final product is a stable aqueous dispersion of polyurethane particles having a solid content of up to about 60% by weight, preferably from about 15 to about 60% by weight, and more preferably from about 30 to about 40% by weight. However, it is always possible to dilute the dispersions to any minimum solids content desired.

### Uses of the Urea Terminated Ether Polyurethanes

The inventive urea terminated ether polyurethanes described herein can be used as a freely added material to a variety of commercial uses included inkjet ink formulations, paints, seed coatings, excipients in pharmaceutical formulations, etc. They can also be used as dispersants for particles such as pigments and disperse dyes and mixtures thereof for ink jet inks.

### EXAMPLES

The following examples are presented for the purpose of illustrating the invention and are not intended to be limiting. All parts, percentages, etc., are by weight unless otherwise indicated.

The dispersions whose preparation is described in the examples below were characterized in terms of their particle size and particle size distribution.

The 1,3-propanediol utilized in the examples was prepared by biological methods and had a purity of >99.8%.

### Ingredients and Abbreviations

DBTL=dibutyltindilaurate

DMEA=dimethylethanolamine

DMIPA=dimethylisopropylamine

DMPA=dimethylol propionic acid

EDA=ethylene diamine

EDTA=ethylenediamine tetraacetic acid

HDI=1,6-hexamethylene diisocyanate

IPDI=isophoronediisocyanate

NMP=n-Methyl pyrolidone

TEA=triethylamine

TEOA=triethanolamine

TETA=triethylenetetramine

THF=tetrahydrofuran

Unless otherwise noted, the above chemicals were obtained from Aldrich (Milwaukee, Wis.) or other similar suppliers of laboratory chemicals.

Poly-G is polypropylene glycol from Arch Chemical, Norwalk Conn.

TERATHANE® 650 is a 650 molecular weight, polytetramethylene ether glycol (PTMEG) from Invista, Wichita, Kans.

TERATHANE® 250 is a 250 molecular weight, polytetramethylene ether glycol (PTMEG)

### Extent of Polyurethane Reaction

The extent of polyurethane reaction was determined by detecting NCO % by dibutylamine titration, a common method in urethane chemistry.

In this method, a sample of the NCO containing prepolymer is reacted with a known amount of dibutylamine solution and the residual amine is back titrated with HCl.

### Particle Size Measurements

The particle size for the polyurethane dispersions, pigments and the inks were determined by dynamic light scattering using a Microtrac® UPA 150 analyzer from Honeywell/Microtrac (Montgomeryville Pa.).

This technique is based on the relationship between the velocity distribution of the particles and the particle size. Laser generated light is scattered from each particle and is Doppler shifted by the particle Brownian motion. The frequency difference between the shifted light and the unshifted light is amplified, digitalized and analyzed to recover the particle size distribution.

The reported numbers below are the volume average particle size.

### Solid Content Measurement

Solid content for the solvent free polyurethane dispersions was measured with a moisture analyzer, model MA50 from Sartorius. For polyurethane dispersions containing high boiling solvent, such as NMP, tetraethylene glycol dimethyl ether, the solid content was then determined by the weight differences before and after baking in 150° C. oven for 180 minutes.

### MW Characterization

All molecular weights were determined by GPC (gel permeation chromatography) using poly(methyl methacrylate) standards with tetrahydrofuran as the elutent. Using statics derived by Flory, the molecular weight of the polyurethane may be calculated or predicted based on the NCO/OH ratio and the molecular weight of the monomers

### Urea Terminated Polyether Diol Example 1 IPDI/T650/DMPA AN45

A 2 L reactor was loaded with 136.7 g Terathane® 650, 84.3 g tetraethylene glycol dimethyl ether, and 32.1 g dimethylol proprionic acid. The mixture was heated to 110° C. with N₂ purge for 1 hr. Then the reaction was cooled to 80° C., and 0.3 g dibutyl tin dilaurate was added. Over 30 minutes 108.9 g isophorone diisocyanate was added followed by 28.2 g tetraethylene glycol dimethyl ether. The reaction was held at 80° C. for 5.5 hrs when the % NCO was below 1.6%. Then, 11.9 g bis(2-methoxy ethyl)amine was added over 5 minutes. After 2 hr at 80° C., the polyurethane solution was inverted under high speed mixing by adding a mixture of 45% KOH (22.8 g) and 320 g water followed by an additional 361.5 g water. The polyurethane dispersion had a viscosity of 20.6 cPs, 23.7% solids, particle size of d50=14 nm and d95=18 nm, and molecular weight by GPC of Mn 6320, Mw 17000, and Pd 2.7. The urea content is 4.1%.

### Urea Terminated Polyether Diol Example 2 IPDI/T650/DMPA AN30

A 2 L reactor was loaded with 154.3 g Terathane® 650, 95.2 g tetraethylene glycol dimethyl ether, and 20.4 g dimethylol proprionic acid. The mixture was heated to 110° C. with N₂ purge for 10 min. Then the reaction was cooled to 80° C., and 0.4 g dibutyl tin dilaurate was added. Over 30 minutes 96.0 g isophorone diisocyanate was added followed by 24.0 g tetraethylene glycol dimethyl ether. The reaction was held at 80° C. for 2 hrs when the % NCO was below 1.2%. Then, 10.6 g bis(2-methoxy ethyl)amine was added over 5 minutes. After 2 hr at 80° C., the polyurethane solution was inverted under high speed mixing by adding a mixture of 45% KOH (16.8 g) and 236 g water followed by an additional 467 g water. The polyurethane dispersion had a viscosity of 11.4 cPs, 25.3% solids, particle size of d50=22 nm and d95=35 nm, and molecular weight by GPC of Mn 6520, Mw 16000, and Pd 2.5. The urea content is 8.8%.

### Urea Terminated Polyether Diol Example 3

### IPDI/1000 PO3G/DMPA AN25

A 2 L reactor was loaded with 245.4 g PO3G (1075 MW) and heated to 110° C. under vacuum until contents had less than 600 ppm water. Then, added 170 g tetraethylene glycol dimethyl ether, and 22.4 g dimethylol proprionic acid. The reactor was cooled to 60° C., and 0.36 g dibutyl tin dilaurate was added. Over 1 hour, 96.7 g isophorone diisocyanate was feed in followed by 21.5 g tetraethylene glycol dimethyl ether. The reaction was held at 80° C. for 2 hrs when the % NCO was below 0.9%. The reaction was cooled to 50° C., and then, 35.3 g of 30 wt. % bis(methoxyethyl)amine in water was added over 5 minutes. After 0.5 hr at 60° C., the polyurethane solution was inverted under high speed mixing by adding a mixture of 45% KOH (18.8 g) and 262.5 g water followed by an additional 631.6 g water. The polyurethane dispersion had a viscosity of 13 cPs, 25.5% solids, and particle size of d50=35 nm and d95=47 nm. The urea content is 2.8%.

### Urea Terminated Polyether Diol Example 4 IPDI/500 PO3G/DMPA AN20

A 2 L reactor was loaded with 214.0 g PO3G (545 MW), 149.5 g tetraethylene glycol dimethyl ether, and 18.0 g dimethylol proprionic acid. The mixture was heated to 110° C. under vacuum until contents had less than 500 ppm water. Then the reaction was cooled to 50 C, and 0.24 g dibutyl tin dilaurate was added. Over 30 minutes 128.9 g isophorone diisocyanate was added followed by 21.2 g tetraethylene glycol dimethyl ether. The reaction was held at 80 C for 3 hrs when the % NCO was below 1.1%. The reaction was cooled to 50° C., and then, 14.1 g bis(2-methoxy ethyl)amine was added over 5 minutes. After 1 hr at 60° C., the polyurethane solution was inverted under high speed mixing by adding a mixture of 45% KOH (15.1 g) and 211.2 g water followed by an additional 727.8 g water. The polyurethane dispersion had a viscosity of 7.86 cPs, 25.5% solids, and particle size of d50=47 nm and d95=72 nm. The urea content is 3.8%.

### Urea Terminated Polyether Diol Example 5 TDI/500 PO3G/DMPA AN30

A 2 L reactor was loaded with 166.4 g PO3G (545 MW), 95.8 g tetraethylene glycol dimethyl ether, and 21.2 g dimethylol proprionic acid. The mixture was heated to 110° C. under vacuum until contents had less than 400 ppm water; approximately 3.5 hrs. Then the reaction was cooled to 70 C, and over 30 minutes, 89.7 g Toluene diisocyanate was added followed by 15.8 g tetraethylene glycol dimethyl ether. The reaction was held at 80° C. for 2 hrs when the % NCO was below 1.5%. Then, 12.4 g bis(2-methoxy ethyl)amine was added over 5 minutes. After 1 hr, removed 50 g for analysis. The remaining polyurethane solution was inverted under high speed mixing by adding a mixture of 45% KOH (15.5 g) and 218.0 g water followed by an additional 464 g water. The polyurethane dispersion had a viscosity of 17.6 cPs, 22.9% solids, particle size of d50=16 nm and d95=35 nm, and molecular weight by GPC of Mn 7465, Mw 15500, and Pd 2.08. The urea content is 4.3%.

### Urea Terminated Polyether Diol Example 6 MDI/500 PO3G/DMPA AN30

The preparation was identical to Diol Example 5 except methylene diphenyl diisocyanate was used instead of toluene diisocyanate and the formulation was adjusted for molecular weight differences in order to maintain the same NCO/OH ratio. The polyurethane dispersion had a viscosity of 23.5% solids, 34 cPs, particle size of d50=18 nm and d95=23 nm, and molecular weight by GPC of Mn 11692, Mw 29141, and Pd 2.49. The urea content is 3.7%.

### Urea Terminated Polyether Diol Example 7 IPDI/500 PO3G/DMPA AN30

The preparation was identical to Diol Example 5 except isophorone diisocyanate was used instead of toluene diisocyanate and the formulation was adjusted for molecular weight differences in order to maintain the same NCO/OH ratio. The polyurethane dispersion had a viscosity of 24.4% solids, 22.1 cPs, particle size of d50=nm and d95=nm, and molecular weight by GPC of Mn 8170, Mw 18084, and Pd 2.21. The urea content is 4.2%.

### Urea Terminated Polyether Diol Example 8 IPDI/1500 PO3G/DMPA AN30

A 2 L reactor was loaded with 194.3 g PO3G (1516 MW), 95.8 g tetraethylene glycol dimethyl ether, and 21.0 g dimethylol proprionic acid. The mixture was heated to 110° C. under vacuum until contents had less than 400 ppm water; approximately 3.5 hrs. Then the reaction was cooled to 70 C, and over 30 minutes, 69.6 g m-isophorone diisocyanate was added followed by 11.6 g tetraethylene glycol dimethyl ether. The reaction was held at 80° C. for 4.5 hrs when the % NCO was below 1.1%. Then, 7.6 g bis(2-methoxy ethyl)amine was added over 5 minutes. After 1 hr, removed 50 g for analysis. The remaining polyurethane solution was inverted under high speed mixing by adding a mixture of 45% KOH (15.4 g) and 216 g water followed by an additional 478 g water. The polyurethane dispersion had a viscosity of 8.8 cPs, 23.2% solids, particle size of d50=12 nm and d95=23 nm, and molecular weight by GPC of Mn 8848, Mw 19048, and Pd 2.15. The urea content is 2.6%.

### Urea Terminated Polyether Diol Example 9 TMXDI/T1000/DMPA AN30

A 2 L reactor was loaded with 221.6 g Terathane 1000 (977 MW), 127.5 g tetraethylene glycol dimethyl ether, and 27.0 g dimethylol proprionic acid. The mixture was heated to 110° C. under vacuum for 1 hour. Then the reaction was cooled to 90° C., and 0.32 g dibutyl tin dilaurate was added. Over 30 minutes 115 g m-Tetramethylene xylylene diisocyanate was added followed by 18.9 g tetraethylene glycol dimethyl ether. The reaction was held at 90° C. for 2 hrs when the % NCO was below 0.7%. Then, 11.4 g bis(2-methoxy ethyl)amine was added over 5 minutes. After 1 hr, the polyurethane solution was inverted under high speed mixing by adding a mixture of 45% KOH (22.6 g) and 316 g water followed by an additional 640 g water. The polyurethane dispersion was 25% solids with mean particle size of d50=34 nm and d95=48 nm. The urea content is 3.0%.

### Urea Terminated Polyether Diol Example 10 IPDI/T650/DMPA AN45

The preparation was identical to Diol Example 1 except additional dimethylol proprionic acid was used to replace some of the Terathane 650 to adjust the final acid number of the polyurethane to 60 mg KOH/g polymer while maintaining the same NCO/OH ratio. This polyurethane dispersion had a viscosity of 21 cPs at 24.1% solids, particle size of d50=19 nm and d95=24 nm, and molecular weight by GPC of Mn 5944.

### Urea Terminated Polyether Diol Example 11 IPDI/PO3G500/DMPA/BMEA/AN45

This example illustrates preparation of an organic solvent-containing aqueous polyurethane dispersion from polytrimethylene ether glycol, isophorone diisocyanate, dimethylolpropionic acid ionic reactant and bis(methoxyethyl) amine chain terminator.

A 2 L reactor was loaded with 214.0 g polytrimethylene ether glycol (Mn of 545), 149.5 g tetraethylene glycol dimethyl ether, and 18.0 g dimethylol proprionic acid. The mixture was heated to 110° C. under vacuum until contents had less than 500 ppm water. The reactor was cooled to 50° C., and 0.24 g dibutyl tin dilaurate was added. 128.9 g isophorone diisocyanate was added over thirty minutes, followed by 21.2 g tetraethylene glycol dimethyl ether. The reaction was held at 80° C. for 3 hrs, and the wt % NCO was determined to be below 1.1%. The reaction was cooled to 50° C., then 14.1 g bis(2-methoxyethyl) amine was added over 5 minutes. After 1 hr at 60° C., the polyurethane solution was inverted under high speed mixing by adding a mixture of 45% KOH (15.1 g) and 211.2 g water, followed by an additional 727.8 g water.

The resulting polyurethane had an acid number of 20 mg KOH/g solids, and the polyurethane dispersion had a viscosity of 7.86 cPs, 25.5 wt % solids, and a particle size of d50=47 nm and d95=72 nm. The urea content is 3.8%.

### Urea Terminated Polyether Diol Example 12 IPDI/T250/DMPA AN40

This example illustrates preparation of an organic solvent-containing, aqueous polyurethane dispersion from polytrimethylene ether glycol, toluene diisocyanate, dimethylolpropionic acid ionic reactant and bis(2-methoxy ethyl) amine chain terminator.

A 2 L reactor was charged with 166.4 g of polytrimethylene glycol ether (Mn of 545), 95.8 g tetraethylene glycol dimethyl ether and 21.2 g dimethylol propionic acid. The mixture was heated to 110° C. under vacuum until the contents had less than 400 ppm water. This required approximately 3.5 hrs. Then the reaction was cooled to 70° C. and, over 30 minutes, 89.7 g of toluene diisocyanate was added followed by 15.8 g of tetraethylene glycol dimethyl ether. The resulting reaction mixture was held at 80° C. for 2 hrs at the end of which time the wt % NCO was determined to be below 1.5%. Then, 12.4 g bis(2-methoxy ethyl)amine was added over 5 minutes. After stirring for 1 hour at 60° C., 50 g was removed for analysis. The remaining polyurethane solution was inverted under high speed mixing by adding a mixture of 45% aqueous KOH (15.5 g) and 218.0 g water followed by an additional 464 g water.

The resulting polyurethane had an acid number of 30 mg KOH/g solids, and the polyurethane dispersion had a viscosity of 17.6 cPs, 22.9% solids, and an average particle size of 16 nm, with 95% below 35 nm A sample dried for analysis had a molecular weight by GPC of Mn 7465 and Mw 15,500. The urea content is 4.3%.

### Urea Terminated Polyether Diol Example 13 IPDI/T250/DMPA AN40

The preparation was identical to Diol Example 12 except the DMPA was adjusted to result in an acid number of 30 and the neutralizing agent was triethylamine.

Preparation of Pigmented Dispersions with Urea Terminated Polyurethanes Utilized as Dispersants.

The pigmented dispersions used in this invention can be prepared using any conventional milling process known in the art. Most milling processes use a two-step process involving a first mixing step followed by a second grinding step. The first step comprises a mixing of all the ingredients, that is, pigment, dispersants, liquid carriers, pH adjuster and any optional additives to provide a blended “premix”. Typically all liquid ingredients are added first, followed by the dispersants and lastly the pigment. Mixing is generally done in a stirred mixing vessel and high-speed dispersers, (HSD), are particularly suitable for the mixing step. A Cowels type blade attached to the HSD and operated at 500 rpm to 4000 rpm, and preferably 2000 rpm to 3500 rpm, provides optimal shear to achieve desired mixing. Adequate mixing is achieved usually in mixing from 15 minutes to 60 minutes.

The second step comprises grinding of the premix to produce a pigmented dispersion. Preferably, grinding occurs by a media milling process although other milling techniques can be used. In this invention a lab-scale Eiger Minimill, model M250, VSE EXP from Eiger Machinery Inc. Chicago, Ill. was used. Grinding was accomplished by charging about 820 grams of 0.5 YTZ zirconia media to the mill. The mill disk speed was operated between 2000 rpm and 4000 rpm and preferably at 3000 rpm and 3500 rpm. The dispersion is processed using a re-circulation grinding process and flow rates though the mill were typically 200 to 500 grams/min. and preferably 300 grams per min. The milling may be done using a staged procedure in which a fraction of the solvent is held out of the grind and added after milling is completed. This amount of solvent held out during milling varies by dispersion and is typically 200 to 400 grams of the total 800-gram batch size. This is done to achieve optimal rheology for grinding efficiency. The invention dispersions each were processed for a total of 4 hours milling time.

After completion of milling process, the dispersion was filled into a polyethylene container. Optionally, the dispersion may be further processed using conventional filtration procedures known in the art. The dispersions may be processed using ultrafiltration techniques that remove co-solvents and other contaminants, ions or impurities from the dispersion. The dispersions were tested for pH, conductivity, viscosity and particle size. To assess dispersion stability, the above properties were remeasured after oven aging of samples for 1 week at 70° C. and noting if significant change versus initial readings had occurred.

Pigmented dispersions were prepared with magenta, yellow, cyan and black pigments. For the examples in Table 1, the following pigments were used Clarient Hostaperm Pink E-02, PR-122 (Magenta), Sun Chemical's Sunbrite Yellow 272-0559, Y-74 (Yellow), Aztech CC 1531 AZ EW (Cyan), and Degussa's Nipex 180 IQ powder (Black, K).

The following procedure was used to prepare the pigment dispersions with invention dispersing resin. Using an Eiger Minimill, the premix was prepared at typically 20-30% pigment loading and the targeted dispersant level was selected at a P/D (pigment/dispersant) ratio of 1.5-3.0. A P/D of 2.5 corresponds to a 40% dispersant level on pigment. In addition, a co-solvent was added at 10% of the total dispersion formulation to facilitate pigment wetting and dissolution of the resins in premix stage and ease of grinding during milling stage. Although other similar co-solvents are suitable, triethylene glycol monobutyl ether (TEB as supplied from Dow Chemical) was the co-solvent of choice. The invention polyurethane resins were neutralized with either KOH or amine to facilitate solubility and dissolution into water. During the premix stage the pigment level was maintained at typically 27% and was subsequently reduced to about 24% during the milling stage by adding deionized water for optimal media mill grinding conditions. After completion of the milling stage, which was typically 4 hours, the remaining letdown of de-ionized water was added and thoroughly mixed. Finally, the dispersion was ultrafiltered to a pigment level of typically 10 to 12%.

All pigmented dispersions were purified using an ultrafiltration process to remove co-solvent(s) and filter out other impurities and ions that may be present. After completion, the pigment levels in the dispersions were reduced to about 10 to 12%. A total of 8 different magenta, 1 yellow, 1 cyan and 3 black dispersions were prepared with the invention dispersing resins.

### Example Pigment Dispersions

Tabulated below are eight magenta pigment dispersions (Examples M1-M8) stabilized with polyurethane dispersants, synthesized by the method previously outlined above. The polyurethane dispersants listed refer to the Polyurethane Dispersants listed above. The polyurethane ionomer was neutralized with KOH to facilitate the dispersion process. Pigmented dispersion examples also included are yellow (Example Y1), cyan (Example C1), and black (Examples K1, K2 and K3) pigment dispersions.

The initial dispersion properties are tabulated and their one-week oven stability results are reported in Table 1 and 2, respectively. The initial particle size, viscosity, and conductivity for these dispersions were 68-144 nm, 3.1-9.8 cPs, and 0.71-2.1 mS/cm, respectively, with the pH ranging from 8.1 to 9.9. The particle size for these dispersions was stable with oven aging with a typical, mean particle size change of 5% with oven aging, but the viscosity and pH did change significantly.

TABLE 1
Pigments Dispersion Examples

| | | | Polyurethane | Particle | | | |
|---|---|---|---|---|---|---|---|
| Pigment | Pig. | Pigment/ | Dispersant | Size d50, | Viscosity | Conductivity | |
| Dispersion | % | Dispersant | Example | nm | (cPs) | (mS/cm) | pH |
| M1 | 11.5 | 2.5 | 3 | 122 | 5.0 | 0.86 | 8.7 |
| M2 | 11.7 | 2.5 | 8 | 144 | 9.8 | 0.84 | 8.5 |
| M3 | 12.3 | 2.5 | 7 | 111 | 7.0 | 0.85 | 8.6 |
| M4 | 11.9 | 2.5 | 6 | 96 | 4.8 | 1.00 | 8.8 |
| M5 | 11.9 | 2.5 | 9 | 103 | 4.9 | 0.81 | 8.5 |
| M6 | 12.5 | 2.5 | 1 | 92 | 5.5 | 1.51 | 9.0 |
| M7 | 11.6 | 2.5 | 10 | 101 | 4.6 | 1.57 | 9.9 |
| M8 | 12.3 | 2.5 | 2 | 100 | 6.6 | 1.28 | 9.3 |
| Y1 | 11.8 | 2.0 | 6 | 109 | 3.1 | 0.71 | 8.1 |
| C1 | 11.2 | 2.5 | 7 | 149 | 3.0 | 0.92 | 8.4 |
| K1 | 11.0 | 2.0 | 7 | 122 | 9.1 | 1.55 | 8.7 |
| K2 | 11.2 | 2.0 | 2 | 68 | 3.6 | 1.03 | 8.2 |
| K3 | 10.8 | 2.0 | 10 | 80 | 3.1 | 2.13 | 8.2 |

TABLE 2
Pigment Dispersion Properties after Oven Aging (70° C. 1 week)

| | Particle | | | |
|---|---|---|---|---|
| Pigment | Size | Viscosity | Conductivity | |
| Dispersion | nm, d₅₀ | (cPs) | (mS/cm) | pH |
| M1 | 124 | 4.4 | 0.97 | 8.7 |
| M2 | 145 | 5.0 | 1.02 | 8.3 |
| M3 | 115 | 4.2 | 1.06 | 8.5 |
| M4 | 96 | 3.3 | 1.37 | 8.9 |
| M5 | 99 | 3.0 | 1.07 | 8.8 |
| M6 | 88 | 4.2 | 1.82 | 9.8 |
| M7 | 99 | 3.7 | 1.89 | 9.9 |
| M8 | 98 | 3.5 | 1.18 | 9.4 |
| Y1 | 114 | 2.3 | 0.91 | 7.8 |
| C1 | 152 | 2.6 | 1.10 | 8.0 |
| K1 | 127 | 6.2 | 1.86 | 7.4 |
| K2 | 72 | 2.6 | 1.46 | 7.2 |
| K3 | 77 | 2.7 | 2.3 | 7.3 |

### Preparation of Inks

The inks were prepared with pigmented dispersions made using invention-dispersing polymers described above, by conventional process known to the art. The pigmented dispersions are processed by routine operations suitable for inkjet ink formulation.

Typically, in preparing ink, all ingredients except the pigmented dispersion are first mixed together. After all the other ingredients are mixed, the pigmented dispersion is added. Common ingredients in ink formulations useful in pigmented dispersions include one or more humectants, co-solvent(s), one or more surfactants, a biocide, a pH adjuster, and de-ionized water.

The pigmented dispersions from example dispersions in Table 2 were prepared into ink formulations in which the targeted percent pigment in ink jet ink was 3.0%. Water, glycerol, 1,2-hexanediol, ethylene glycol, Surfynol 465, 2-pyrrolidine, and Proxel GXL were mixed with the prepared pigment dispersions in the percentages detailed in Table 3. Proxel GXL is a biocide available from Avecia, Inc. and Surfynol 465 is a surfactant available from Air Products. The inks were mixed for 4 hours and then filtered through a 1 micron filtration apparatus, removing any large agglomerates, aggregates or particulates.

TABLE 3
Ink Composition

| | Weight % in |
|---|---|
| Ink Ingredient | Ink |
| 1,2 hexanediol | 4.00% |
| glycerol | 15.00% |
| Ethylene glycol | 5.00% |
| Surfynol 465 | 0.50% |
| 2-Pyrrolidone (94.5% | 3.00% |
| active) | |
| Proxel GXL | 0.14% |
| Pigment | 3% |
| Water (Balance to 100%) | balance |

### Ink Properties

The ink properties measured were pH, viscosity, conductivity, particle size and surface tension. The particle size was measured using a Leeds and Northrup, Microtrac Ultrafine Particle Analyser (UPA). The viscosity was measured with a Brookfield Viscometer (Spindle 00, 25° C., 60 rpm). The properties of the inks prepared using example dispersions containing invention dispersing resins are reported in Table 4. For these inks, the particle size, viscosity, conductivity, and surface tension were 71-143 nm, 2.6-3.4 cPs, 0.25-0.46 mS/cm and 31-33 dynes/cm, respectively, with the pH ranging from 7.2 to 8.5.

Jet velocity, drop size and stability are greatly affected by the surface tension and the viscosity of the ink. Inkjet inks typically have a surface tension in the range of about 20 dyne/cm to about 60 dyne/cm at 25° C. Viscosity can be as high as 30 cPs at 25° C., but is typically significantly lower. The inks have physical properties compatible with a wide range of ejecting conditions, i.e., driving frequency of the piezo element, or ejection conditions for a thermal head, for either a drop-on-demand device or a continuous device, and the shape and size of the nozzle. The inks of this invention should have excellent storage stability for long periods so as not clog to a significant extent in an ink jet apparatus. Further, it should not alter the materials of construction of the ink jet printing device it comes in contact with, and be essentially odorless and non-toxic.

Although not restricted to any particular viscosity range or printhead, the inventive inks are suited to lower viscosity applications such as those required by higher resolution (higher dpi) printheads that jet small droplet volumes, e.g. less than about 20 pL. Thus the viscosity (at 25° C.) of the inventive inks can be less than about 7 cPs, is preferably less than about 5 cPs, and most advantageously is less than about 3.5 cPs.

TABLE 4
Ink Properties of Pigmented Inks using Polyurethane Dispersants

| | | | | Particle | Surface |
|---|---|---|---|---|---|
| | | Conductivity | Viscosity | Size | Tension |
| Ink | pH | (us/cm) | (cPs) | d₅₀ | dynes/cm |
| Ink-M1 | 8.2 | 0.25 | 3.04 | 143 | 32.7 |
| Ink-M2 | 8.0 | 0.26 | 3.26 | 143 | 32.8 |
| Ink-M3 | 8.0 | 0.25 | 3.01 | 119 | 32.9 |
| Ink-M4 | 8.2 | 0.29 | 2.80 | 93 | 33 |
| Ink-M5 | 7.9 | 0.23 | 2.77 | 99 | 32.7 |
| Ink-M6 | 8.3 | 0.36 | 3.06 | 91 | 32.8 |
| Ink-M7 | 8.3 | 0.39 | 3.12 | 99 | 32.8 |
| Ink-M8 | 8.4 | 0.26 | 2.87 | 103 | 32.5 |
| Ink-Y1 | 7.8 | 0.26 | 2.60 | 112 | 31.9 |
| Ink-C1 | 7.9 | 0.26 | 2.79 | 133 | 32.7 |
| Ink-K1 | 8.5 | 0.36 | 3.38 | 130 | 32.7 |
| Ink-K2 | 8.1 | 0.29 | 2.80 | 71.4 | 32.7 |
| Ink-K3 | 7.9 | 0.46 | 3.05 | 72.0 | 33 |

### Print Properties

The Ink printing was done using a commercially available Epson 980 piezo printhead type printer although any suitable inkjet printer could be used. Inkjet inks with invention dispersing resins were printed on three different commercially available paper substrates included Hammermill Copy Plus, Xerox X4024 and Epson Photo Glossy Premium papers. Coral Draw 10 was used to generate color targets as a function of percent area coverage. For plain papers (Hammermill Copy Plus and Xerox X4024), the printer was set to mode: Normal-720 dpi and no color adjustment. Printing on Epson Glossy Photo paper was done using Photo mode-1440 dpi and no color adjustment.

Key properties include color on plain paper, photo-quality on photo paper (color, gloss and DOI) and print performance. Color measurements, specifically chroma and hue, were performed using a Gretag Macbeth Spectroeye model 36.64.00 calorimeter. To ascertain photo-quality of prints, distinctness-of-image (DOI) was measured with a BYK Gardner model 4816 Wavescan meter and gloss was measured with a BYK Gardner model 4520 Glossmeter. Printing performance was measured by measuring the nozzle outs after 5 pages. A nozzle check pattern was printed before and after printing 5 solid pages at 100% coverage.

The printing results using an Epson 980 piezo type printer, for selective inks make with pigments stabilized by invention dispersing resins are reported in Table 6. The color on plain paper (Hammermill copy plus) for the Magenta inks had a hue angle of 344 to 349 and chroma of 65.4 to 67.6 with ODs ranging from 0.85 to 1.0. The yellow and cyan prints had a hue angle of 95.4 and 258.2, chroma of 85.1 and 54.7, and OD of 0.93 and 0.87, respectively. Black prints on plain paper had a hue angle of 29-346.4, chroma of 0.7-1, and OD of 0.86-0.94. While the color, especially chroma/OD, was enhanced by the photo paper due to the hold-up of the colorant on this substrate, pigment dispersions with these inventive polyurethanes resulted in dye-like gloss and DOI with 60° gloss and DOI values of 85-126 and 1.8-2.6, respectively. Most of the inks were ink jet printed with only 0 to 2 nozzle outs after 5 solid pages, and only one ink have a notable number of nozzle outs. For reference, the Epson 980 printer has 192-nozzle printhead for black and 96-nozzle printhead for CYM. In general, these inks printed without any significant issues.

TABLE 5
Print Properties of Pigmented Inks with Polyurethane Dispersants

| | | | | Epson Premium Photo Glossy | | | | | |
|---|---|---|---|---|---|---|---|---|---|
| | Hammermill Copy Plus | | | | | | 60° | | Nozzle |
| Ink | OD | Chroma | Hue | OD | Chroma | Hue | Gloss | DOI | outs |
| Ink-M1 | 1.00 | 68 | 347 | 1.74 | 88 | 346 | 97 | 2.3 | 9 |
| Ink-M2 | 0.91 | 65 | 348 | 1.87 | 89 | 348 | 110 | 2.3 | 0 |
| Ink-M3 | 0.92 | 66 | 348 | 1.83 | 89 | 348 | 102 | 2.1 | 0 |
| Ink-M4 | 0.90 | 66 | 348 | 1.91 | 90 | 347 | 107 | 2.2 | 0 |
| Ink-M5 | 0.90 | 66 | 347 | 1.95 | 91 | 347 | 106 | 2.3 | 0 |
| Ink-M6 | 0.87 | 66 | 346 | 1.96 | 93 | 345 | 111 | 2.1 | 1 |
| Ink-M7 | 0.85 | 66 | 346 | 1.88 | 93 | 344 | 110 | 2 | 0 |
| Ink-M8 | 0.87 | 66 | 345 | 1.81 | 93 | 344 | 105 | 2.5 | 2 |
| Ink-Y1 | 0.93 | 85 | 95 | 1.37 | 110 | 92 | 100 | 2.4 | 0 |
| Ink-C1 | 0.87 | 55 | 258 | 1.63 | 79 | 265 | 85 | 2.6 | 1 |
| Ink-K1 | 0.94 | 1 | 29 | 2.00 | 3 | 265 | 102 | 1.8 | 0 |
| Ink-K2 | 0.91 | 0.7 | 346 | 1.98 | 2.3 | 268 | 126 | 2.4 | 0 |
| Ink-K3 | 0.86 | 0.7 | 323 | 1.96 | 2.5 | 266 | 104 | 1.9 | 2 |

Five black inks were prepared that show other uses of the urea terminated polyurethanes. Inks K4-K7 show the use of urea terminated polyurethane as both a dispersant and as a polymer ink additive. Ink K8 shows the use of the urea terminated polyurethane as a freely additive to an ink which is based on an ionically stabilized dispersant described in US20050090599.

TABLE 6
Black inks with urea terminated polyurethanes

| | | | | | Optical | |
|---|---|---|---|---|---|---|
| | | | | Optical | Density | Optical |
| Ink | Dispersant | % | Polymer | Density | Xerox | Density |
| Example | — | pigment | ink additive | HCP | 4200 | SO41286 |
| Inv. K4 | PUD # 4 | 1.5% | PUD ink add. # 4 | 0.75 | 0.82 | 1.85 |
| Inv. K5 | PUD # 4 | 3.0% | PUD ink add. # 4 | 1.01 | 1.03 | 1.98 |
| Inv. K6 | PUD # 4 | 4.5% | PUD ink add. # 4 | 1.10 | 1.14 | 1.93 |
| Inv. K7 | PUD # 4 | 6.0% | PUD ink add. # 4 | 1.16 | 1.22 | 1.86 |
| Inv. K8 | Dispersant(1) | 6% | 1% of PUD ink add. # 4 | 1.01 | 1.12 | 1.89 |

(1)Dispersant, Example 2a from US20050090599

Printing Properties Textiles

The Inkjet inks with invention dispersing resins were printed using a commercially available Epson 3000 piezo printhead type printer although any suitable inkjet printer could be used. The substrate used was 419 100% cotton from Testfabrics. The printed textiles may optionally be post processed with heat and/or pressure, such as disclosed in US20030160851 (the disclosure of which is incorporated by reference herein for all purposes as if fully set forth. In this case, all test prints were fused at about 170° C. for about 2 minutes.

Colorimetric measurements were done using a Minolta Spectrophotometer CM-3600d using Spectra Match software.

Where indicated the printed textile was tested for washfastness according to methods developed by the American Association of Textile Chemists and Colorists, (AATCC), Research Triangle Park, N.C. The AATCC Test Method 61-1996, “Colorfastness to Laundering, Home and Commercial: Accelerated”, was used. In that test, colorfastness is described as “the resistance of a material to change in any of its color characteristics, to transfer of its colorant(s) to adjacent materials or both as a result of the exposure of the material to any environment that might be encountered during the processing, testing, storage or use of the material.” Tests 3A was done and the color washfastness and stain rating were recorded. The ratings for these tests are from 1-5 with 5 being the best result, that is, little or no loss of color and little or no transfer of color to another material, respectively. Crock measurements were made using methodology described in AATCC Test Method 8-1996.

The printing results using an Epson 3000 piezo type printer, for selective inks make with pigments stabilized by invention dispersing resins are reported in Table 7.

TABLE 7
Print Properties of Pigmented Inks with Polyurethane Dispersants

| | | 3A | | |
|---|---|---|---|---|
| Ink | OD | washfastness | Dry Crock | Wet Crock |
| Ink-M1 | 1.02 | 4.5 | 3.5 | 3.0 |
| Ink-M2 | 1.02 | 4.0 | 3.5 | 3.0 |
| Ink-M3 | 1.04 | 4.5 | 3.0 | 3.0 |
| Ink-M5 | 1.03 | 4.5 | 3.0 | 2.5 |

The inventive urea terminated polyurethane dispsersants provide excellent performance for textile printing.

A black ink was prepared according to the following composition and tested for printing on textiles.

TABLE 8
Ink Composition

| | Weight % in |
|---|---|
| Ink Ingredient | Ink |
| Urea Terminated Polyether | 3.0% |
| Diol Example 13 | |
| Glycerol | 24.00% |
| Ethylene glycol | 5.00% |
| Surfynol 440 | 1.0% |
| Crosslinked polyurethane (1) | 3.00% |
| Proxel GXL | 0.16% |
| SDP Pigment (2) | 6% |
| Water (Balance to 100%) | balance |

(1) Crosslinked polyurethane is described in example 2 of US2005018154
(2) U.S. Pat. No. 6,852,156 example 1.

### Ink Properties

| | | | | Particle | Surface |
|---|---|---|---|---|---|
| | | Conductivity | Viscosity | Size | Tension |
| Ink | pH | (us/cm) | (cPs) | d₅₀ | dynes/cm |
| Ink-1 | 7.6 | 0.7 | 6.73 | 133 | 32.4 |

Printed Ink Performance on 100% Cotton (419 from Testfabrics); fused at 190 C/1 min

| | | Dry | Wet | 3A | Print |
|---|---|---|---|---|---|
| Ink | OD | Crock | Crock | wash | Rating |
| Ink-1 | 1.21 | 3.1 | 1.8 | 2.4 | Good |

Printed Ink Performance on Polyester/Cotton Blend (7409 from Testfabrics); fused at 170 C/2 min

| | | Dry | Wet | 3A | Print |
|---|---|---|---|---|---|
| Ink | OD | Crock | Crock | wash | Rating |
| Ink-1 | 1.21 | 3.1 | 1.8 | 2.4 | Good |

What is claimed is:

1. An aqueous dispersion of a polyurethane composition comprising at least one compound of the general structure (I): 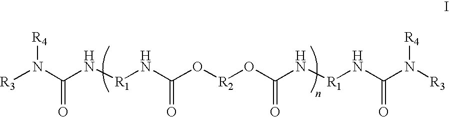
R₁=alkyl, substituted alkyl, substituted alkyl/aryl from a diisocyanate,
R₂=alkyl, substituted/branched alkyl from a diol,
R₃=alkyl, a non-isocyanate reactive substituted/branched alkyl from an amine terminating group,
R₄=hydrogen, alkyl, a non-isocyanate reactive substituted/branched alkyl from the amine terminating group;
n=2 to 30;
and where R₂=Z₁ or Z₂ and at least one Z₁ and at least one Z₂ must be present in the polyurethane composition; 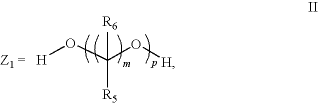
m greater than or equal to 3 to about 12,
p greater than or equal to 2,
R₅, R₆=hydrogen, alkyl, substituted alkyl, aryl; where the R₅ is the same or different with each —CR₅R₆; where R₅ and R₅ or R₆ can be joined to form a cyclic structure;
Z₂ is a diol substituted with an ionic group;
wherein the urea content of the urea-terminated polyurethane is at least 2 wt % of the polyurethane and at most about 14 wt % of the polyurethane.

2. The polyurethane of claim 1 where the urea terminated polyurethane part of the polyurethane is at least 2.5 wt % and at most 10.5 wt %

3. The polyurethane of claim 1 where the polyether diol of Structure II is at least 50 weight percent of the polyether diol.

4. The polyurethane of claim 1 where the polyether diol of Structure II is at least 75 weight percent of the polyether diol.

5. The polyurethane of claim 1 where the polyether diol of Structure II is at least 90 weight percent of the polyether diol.

6. The polyurethane of claim 1 where the polyether diol of Structure II has a number average molecular weight of 200 to 5000.

7. The polyurethane of claim 1 where the polyether diol of Structure II has a number average molecular weight of 240 to 3600.

8. The polyurethane of claim 1 where the polyether diol of Structure II has m=3 or 4.

9. The polyurethane of claim 8 where R₅ and R₆ are hydrogen.

10. The polyurethane of claim 1 where the polyether diol of Structure II m=3 and the ether is group is derived from biochemical transformations.

11. The polyurethane of claim 1 where Groups R₃ and R₄ are alkyl.

12. The polyurethane of claim 1 where Groups R₃ and R₄ are substituted with nonionic hydrophilic groups.

13. The polyurethane of claim 1 where Groups R₃ and R₄ are methoxyethyl.

14. The polyurethane composition of claim 1 where the ionic content of the polyurethane is 10 to 210 milliequivalents per 100 g of polyurethane.

15. The polyurethane composition of claim 1 where the ionic content of the polyurethane is 20 to 140 milliequivalents per 100 g of polyurethane.

16. A method of preparation of a polyurethane composition comprising a urea terminated polyurethane comprising the steps:
(a) providing reactants comprising (i) at least one diol Z₁ (ii) at least one polyisocyanate component comprising a diisocyanate, and (iii) at least one hydrophilic reactant comprising at least one isocyanate reactive ingredient containing an ionic group, Z₂;
(b) contacting (i), (ii) and (iii) in the presence of a water-miscible organic solvent to form an isocyanate-functional polyurethane prepolymer;
(c) adding water to form an aqueous dispersion; and
(d) prior to, concurrently with or subsequent to step (c), chain-terminating the isocyanate-functional prepolymer with a primary or secondary amine.
